(19) United States
(12) Patent Application Publication
(10) Pub. No.: US 2025/0068911 A1
(43) Pub. Date: Feb. 27, 2025

(54) METHODS AND SYSTEMS FOR MITIGATING NEGATIVE TRANSFER IN MULTI-TASK LEARNING

(71) Applicant: MASTERCARD INTERNATIONAL INCORPORATED, PURCHASE, NY (US)

(72) Inventors: Aakarsh Malhotra, New Delhi (IN); Sonia Gupta, Gurgaon (IN); Akshay Sethi, New Delhi (IN); Siddhartha Asthana, New Delhi (IN)

(21) Appl. No.: 18/455,546

(22) Filed: Aug. 24, 2023

(51) Int. Cl. G06N 3/084

(52) U.S. Cl. CPC G06N 3/084

(57) ABSTRACT

Methods and server systems for mitigating negative transfer in Multi-Task Learning (MTL) are described herein. Method performed by server system includes accessing training dataset and training multi-task machine learning (MTML) model based on performing operations. The operations includes initializing MTML model based on model parameters. Then, computing task affinity metric for each task of a set of tasks based on determining an affinity between each task and one or more tasks. Then, computing task-specific activation probability for each task based on task affinity metric corresponding to each task. Then, activating subset of tasks when task-specific activation probability corresponding to each individual task from the subset of tasks is lower than predefined threshold. Further, processing, via MTML model, training dataset by performing subset of tasks to compute outputs. Furthermore, generating task-specific losses for subset of tasks based on outputs and training dataset. Thereafter, optimizing model parameters based on back-propagating task-specific losses.

### TECHNICAL FIELD

The present disclosure relates to artificial intelligence-based processing systems and, more particularly, to electronic methods and complex processing systems for mitigating negative transfer in Multi-Task Learning (MTL).

### BACKGROUND

In the Artificial Intelligence (AI) or Machine Learning (ML) domain, various learning techniques have been developed for training AI and ML models. One such popular learning technique is known as Multi-Task Learning (MTL). In MTL, an Al or ML model is trained to perform multiple tasks simultaneously. More specifically, in deep learning, MTL involves training a neural network to perform multiple tasks by sharing one or more network layers from the various network layers and sharing one or more parameters of the neural network across multiple tasks. The objective of MTL is to improve the generalization performance of the trained model by leveraging the information shared across the different tasks. As may be understood, by sharing one or more parameters of the neural network, the AI or ML model can learn a representation of the training data (i.e., the data used for training the model) more efficiently. Furthermore, MTL provides various advantages such as improved data efficiency, quick model convergence, reduced over-fitting of the trained model due to shared representations (or embeddings), and the like. In various non-limiting examples, MTL is useful for training AI or ML models for various applications such as Natural Language Processing (NLP), Computer Vision (CV), healthcare, finance, and the like. In an example implementation, in computer vision, a single ML model for face recognition may be trained using MTL for performing various computer vision tasks such as gender recognition, landmark localization, image de-noising, pose estimation, object analysis, and the like.

However, it may be noted that the conventional MTL techniques suffer from various disadvantages during the training process due to the factors such as imbalanced training datasets, dissimilarity between tasks, negative transfer of knowledge, different levels in the difficulty of tasks for which the model has to be trained, different output space for different tasks, and the like. In simpler terms, during MTL when different tasks of varying natures and complexity are being used to train a single model, a few tasks might dominate the learning process, whereas for other tasks, the respective performance of the model might be compromised due to negative transfer from the dominating tasks. The term ‘negative transfer’ refers to a common problem faced while learning multiple tasks simultaneously, which results in lower accuracy than learning only a single target task. Negative transfer is often attributed to the gradient conflict between different tasks during the learning process.

In order to address these disadvantages, a technique known as a ‘Dropped Scheduled Task (DST)’ algorithm has been developed. In DST, one or more tasks are dropped or deactivated probabilistically during the joint optimization in the MTL while scheduling the remaining tasks to stay activated, which in turn, results into reducing the negative transfer. In particular, a task-specific activation probability is computed for each task of the set of tasks. More specifically, the task-specific activation probability is computed based, at least in part, on a set of metrics. In a non-limiting example, the set of metrics may include a task depth, a number of ground truth samples per task, the amount of training completed, and task stagnancy. Furthermore, one or more tasks from the set of tasks may be scheduled to stay activated or deactivated based, at least in part, on the task-specific activation probability.

However, it is noted that the independent task-level activation in the DST approach can cause dissimilar tasks to be activated or switched ON which reduces the performance of the model trained using this approach. Further, this approach may cause the learning from the tasks to become stagnant due to a particular task completing early or a particular task failing to have ample priority during the training.

Thus, there exists a technological need for technical solutions for mitigating negative transfer in Multi-Task Learning (MTL) without the disadvantages of the existing approach.

### SUMMARY

Various embodiments of the present disclosure provide methods and systems for mitigating negative transfer during Multi-Task Learning (MTL) while training a machine learning model.

In an embodiment, a computer-implemented method for performing Multi-Task Learning (MTL) while mitigating negative transfer is disclosed. The computer-implemented method performed by a server system includes accessing a training dataset for training a multi-task machine learning (MTML) model for a set of tasks from a database associated with the server system. The method further includes training the MTML model based, at least in part, on performing a set of operations for a plurality of iterations till the performance of the MTML model converges to a predefined criteria. Herein, the set of operations includes initializing the MTML model based, at least in part, on one or more model parameters. Herein, the MTML model includes a set of shared layers and a set of task-specific heads. Such that, each task-specific head of the set of task-specific heads includes a set of task-specific layers corresponding to an individual task from the set of tasks. The set of operations further includes computing a task affinity metric for each task of the set of tasks based, at least in part, on determining an affinity between the each task and one or more tasks from the set of tasks. The set of operations further includes computing a task-specific activation probability for the each task of the set of tasks based, at least in part, on the task affinity metric corresponding to the each task. The set of operations further includes activating a subset of tasks from the set of tasks based, at least in part, on the task-specific activation probability corresponding to each individual task from the subset of tasks being lower than a predefined threshold. The set of operations further includes processing, via the MTML model, the training dataset by performing the subset of tasks to compute a set of outputs. The set of operations further includes generating a set of task-specific losses for the subset of tasks based, at least in part, on the set of outputs and the training dataset. The set of operations further includes optimizing the one or more model parameters based, at least in part, on back-propagating the set of task-specific losses.

In another embodiment, a server system is disclosed. The server system includes a communication interface and a memory including executable instructions. The server system also includes a processor communicably coupled to the memory. The processor is configured to execute the instructions to cause the server system, at least in part, to access a training dataset for training a multi-task machine learning (MTML) model for a set of tasks from a database associated with the server system. The system is further caused to train the MTML model based, at least in part, on performing a set of operations for a plurality of iterations till the performance of the MTML model converges to a predefined criteria. Herein, the set of operations includes initializing the MTML model based, at least in part, on one or more model parameters. Herein, the MTML model includes a set of shared layers and a set of task-specific heads. Such that, each task-specific head of the set of task-specific heads includes a set of task-specific layers corresponding to an individual task from the set of tasks. The set of operations further includes computing a task affinity metric for each task of the set of tasks based, at least in part, on determining an affinity between the each task and one or more tasks from the set of tasks. The set of operations further includes computing a task-specific activation probability for the each task of the set of tasks based, at least in part, on the task affinity metric corresponding to the each task. The set of operations further includes activating a subset of tasks from the set of tasks based, at least in part, on the task-specific activation probability corresponding to each individual task from the subset of tasks being lower than a predefined threshold. The set of operations further includes processing, via the MTML model, the training dataset by performing the subset of tasks to compute a set of outputs. The set of operations further includes generating a set of task-specific losses for the subset of tasks based, at least in part, on the set of outputs and the training dataset. The set of operations further includes optimizing the one or more model parameters based, at least in part, on back-propagating the set of task-specific losses.

In yet another embodiment, a non-transitory computer-readable storage medium is disclosed. The non-transitory computer-readable storage medium includes computer-executable instructions that, when executed by at least a processor of a server system, cause the server system to perform a method. The method includes accessing a training dataset for training a multi-task machine learning (MTML) model for a set of tasks from a database associated with the server system. The method further includes training the MTML model based, at least in part, on performing a set of operations for a plurality of iterations till the performance of the MTML model converges to a predefined criteria. Herein, the set of operations includes initializing the MTML model based, at least in part, on one or more model parameters. Herein, the MTML model includes a set of shared layers and a set of task-specific heads. Such that, each task-specific head of the set of task-specific heads includes a set of task-specific layers corresponding to an individual task from the set of tasks. The set of operations further includes computing a task affinity metric for each task of the set of tasks based, at least in part, on determining an affinity between the each task and one or more tasks from the set of tasks. The set of operations further includes computing a task-specific activation probability for the each task of the set of tasks based, at least in part, on the task affinity metric corresponding to the each task. The set of operations further includes activating a subset of tasks from the set of tasks based, at least in part, on the task-specific activation probability corresponding to each individual task from the subset of tasks being lower than a predefined threshold. The set of operations further includes processing, via the MTML model, the training dataset by performing the subset of tasks to compute a set of outputs. The set of operations further includes generating a set of task-specific losses for the subset of tasks based, at least in part, on the set of outputs and the training dataset. The set of operations further includes optimizing the one or more model parameters based, at least in part, on back-propagating the set of task-specific losses.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

For a more complete understanding of example embodiments of the present technology, reference is now made to the following descriptions taken in connection with the accompanying drawings in which:

FIG. 1 illustrates an example representation of an environment related to at least some example embodiments of the present disclosure;

FIG. 2 illustrates a simplified block diagram of a server system, in accordance with an embodiment of the present disclosure:

FIG. 3 illustrates an example representation of a conventional architecture of Multi-Task Learning using Dropped Scheduled Task (DST), in accordance with an example of the present disclosure:

FIG. 4 illustrates an example representation of an architecture of a Multi-Task Machine Leaning (MTML) model, in accordance with an embodiment of the present disclosure;

FIG. 5 illustrates a process flow diagram depicting a method for mitigating negative transfer during Multi-Task Learning (MTL) while training a machine learning model, in accordance with an embodiment of the present disclosure; and

FIG. 6 illustrates a process flow diagram depicting a method for initializing a Multi-Task Machine Leaning (MTML) model, in accordance with an embodiment of the present disclosure.

The drawings referred to in this description are not to be understood as being drawn to scale except if specifically noted, and such drawings are only example in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, a system, a method, or a computer program product. Accordingly, embodiments of the present disclosure may take the form of an entirely hardware embodiment, an entirely software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

### Overview

Various embodiments of the present disclosure provide methods, systems, user devices, and computer program products for mitigating negative transfer during Multi-Task Learning (MTL) while training a machine learning model.

To that end, the present disclosure aims to solve a technical problem related to how to mitigate negative transfer in MTL while avoiding gradient conflict. The present disclosure solves this technical problem by providing a technical effect that addresses the disadvantages of the conventional approaches for performing the MTL while mitigating negative transfer during the MTL process as well. More specifically, by scheduling a subset of tasks from a set of tasks to be activated or deactivated (in other words, switch ON or OFF) during the MTL process for the MMTL model based on the task affinity and the inter-task groupings based on the task affinity metric enables the performance of an AI or ML model thus trained to be improved significantly. Further, since similar tasks or tasks with affinity to each other are activated together, the problem of gradient conflicts faced by the conventional approaches is also addressed. Furthermore, by initializing the MMTL model with a bias for the weakest task during the first iteration during the learning process, the overall efficiency of the MMTL model while learning representations from the weaker tasks from the set of tasks is improved.

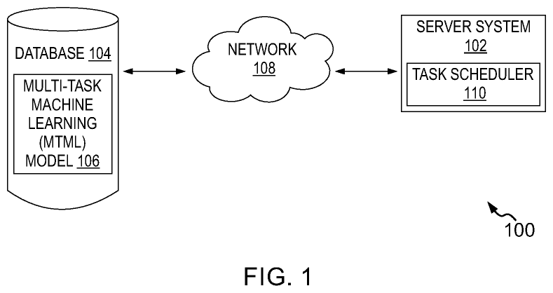

Various embodiments of the present disclosure are described hereinafter with reference to FIGS. 1 to 6.

FIG. 1 illustrates an example representation of an environment 100 related to at least some embodiments of the present disclosure. Although the environment 100 is presented in one arrangement, other embodiments may include the parts of the environment 100 (or other parts) arranged otherwise depending on, for example, training an AI or ML model using MTL techniques, mitigating negative transfer from stronger or dominant tasks to weaker tasks during MTL, promoting positive transfer between different tasks from the set of tasks used for performing MTL for the AI or ML model and the like.

The environment 100 generally includes a plurality of components such as a server system 102 and a database 104 each coupled to, and in communication with (and/or with access to) a network 108. It is noted that various other components may also be present in the environment 100 for facilitating the training of AI or ML models using MTL by performing a set of tasks.

In an embodiment, the network 108 may include, without limitation, a Light Fidelity (Li-Fi) network, a Local Area Network (LAN), a Wide Area Network (WAN), a Metropolitan Area Network (MAN), a satellite network, the Internet, a fiber optic network, a coaxial cable network, an Infrared (IR) network, a Radio Frequency (RF) network, a virtual network, and/or another suitable public and/or private network capable of supporting communication among two or more of the parts or users illustrated in FIG. 1, or any combination thereof.

Various entities/components in the environment 100 may connect to the network 108 in accordance with various wired and wireless communication protocols, such as Transmission Control Protocol/Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, future communication protocols or any combination thereof. For example, the network 106 may include multiple different networks, such as a private network made accessible by the server system 102 and a public network (e.g., the Internet, etc.) through which the server system 102 may communicate with the database 104.

In an embodiment, the database 104 may be a data repository designed to efficiently store and manage information. In some embodiments, the database 104 may be integrated into the server system 102. For example, the server system 102 may include one or more hard disk drives as the database 104. In various non-limiting examples, the database 104 may include one or more hard disk drives (HDD), solid-state drives (SSD), an Advanced Technology Attachment (ATA) adapter, a Serial ATA (SATA) adapter, a Small Computer System Interface (SCSI) adapter, a redundant array of independent disks (RAID) controller, a storage area network (SAN) adapter, a network adapter, and/or any component providing the server system 102 with access to the database 104. In one implementation, the database 104 may be viewed, accessed, amended, updated, and/or deleted by an administrator (not shown) associated with the server system 102 through a database management system (DBMS) or relational database management system (RDBMS) present within the database 104.

In another embodiment, the database 104 may store an AI or ML model such as a Multi-Task Machine Learning (MTML) model 106. In an embodiment, the MTML model 106 is an Al or ML model that is trained or learned to perform a set of tasks that are related to each other. The aim behind training the model using a set of tasks is to share information or insights learned from different tasks across the whole model to improve the overall performance of the MTML model 106. In various non-limiting examples, the architecture of machine learning models that utilize multi-task learning generally includes a few components such as a set of shared layers, a set of task-specific heads, and a set of loss functions. In particular, for training the MTML model 106 using MTL, the MTML model 106 has to be trained to perform a set of tasks (generally known as pretext tasks).

In an embodiment, the set of shared layers of the MTML model 106 enables the MTML model 106 to learn a shared representation of the input data (also, known as training data) across the set of tasks. It is noted that in some embodiments, the training data may be present in a training dataset that may be accessed by the MTML model 106 from the database 104 as well. In other words, the set of shared layers is responsible for extracting common representations and patterns that are relevant to all the tasks from the set of tasks being learned by the MTML model 106. As may be understood, the set of shared layers enables the MTML model 106 to learn from the set of tasks without the need for creating or training separate AI or ML models for learning each individual task from the set of tasks. It is noted that the set of shared layers is typically present at the beginning of the MTML model 106 and is responsible for processing the raw data from the training dataset to extract common features that are relevant across the set of tasks. In other words, the set of shared layers pre-processes the training data to determine features that may be useful for learning from the set of tasks by the MTML model 106. In various non-limiting examples, the set of shared layers may be implemented using a variety of neural network layers such as, but not limited to, convolutional layers, recurrent layers, transformer layers, dense layers), etc., among other suitable neural networks.

In an embodiment, during the training of the MTML model 106, the set of shared layers processes the representations learned by the task-specific heads (described later) from the set of tasks. As may be understood, by sharing the set of layers, the MTML model 106 is able to extract common or informative representations that may benefit all tasks from the set of tasks. In an implementation, the set of shared layers may also back-propagate the gradients (or losses) determined by the set of loss functions (described later) from all tasks from the set of tasks to learn a set of representations. It is noted that since, the set of representations is learned from the set of tasks and the shared information between these tasks, the set of representations thus, learned may capture both the shared and task-specific knowledge. To that end, when the MTML model 106 trained using MTL by the set of representations is deployed in real-world applications, the overall prediction performance of the MTML model 106 will be improved and accurate.

In an embodiment, the set of task-specific heads is configured to learn a set of tasks based, at least in part, on the set of representations shared by the set of shared layers. In particular, each task-specific head of the set of task-specific heads is configured to process the set of representations shared by the set of shared layers to adopt its predictions or learnings for each corresponding task from the set of tasks. In other words, the each task-specific head from the set of task-specific heads allows the MTML model 106 to learn while adapting its output using the set of representations for each specific task corresponding to it. In a non-limiting example, each task-specific head of the set of task-specific heads may further include a set of task-specific layers corresponding to an individual or specific task from the set of tasks. In various non-limiting examples, the set of task-specific layers may be implemented using a variety of neural network layers such as but not limited to convolutional layers, recurrent layers, attention mechanisms (such as self-attention mechanisms), transformer layers, dense layers, etc., among other suitable neural networks.

In an embodiment, during the training of the MTML model 106, the set of task-specific layers corresponding to each task-specific head is configured to receive the set of representations from the set of shared layers and process them to make predictions for the corresponding specific task of the task-specific head. Further, the set of task-specific layers corresponding to each task-specific head from the set of task-specific heads are configured to back-propagate the gradients (or losses) determined by the set of loss functions (described later) from the task through the task-specific head to fine-time or optimize the set of task-specific layers for that task-specific head of the MTML model 106 to improve the task-specific performance of the task-specific head.

In an embodiment, the set of loss functions is configured to determine or quantify the difference (i.e., loss or gradient) in the predictions made by the set of task-specific heads or the MTML model 106 and an actual value that the prediction should have been. It is understood that while training any AI or ML model, the training dataset is split into training data, testing data, and validation data. In other words, the predictions made by a model in terms of predicted values for an outcome can easily be validated using the training dataset that has the actual value for the actual outcome. This actual value is also known as a target value as well. In other words, the set of loss functions is configured to determine a loss value or a set of loss values between the predicted value and the target value. As may be understood, this loss value or the set of loss values may be fed back to the MTML model 106 to adjust its operating parameters during the model training process. This act helps to reduce a loss in the next training cycle of the MTML model 106. As may be understood, this process may be repeated a number of times till either the set of loss values cease to exist or more likely, the set of loss values saturates or becomes stagnant between subsequent training cycles. In various non-limiting examples, the set of loss functions may include but are not limited to feature reconstruction loss function, topological reconstruction, contrastive learning loss, mutual information maximization loss, mean squared error (MSE), cross-entropy loss, categorical cross-entropy loss, Huber loss and the like.

In an embodiment, during the training of the MTML model 106, the MTML model 106 is configured to minimize the loss generated by the set of loss functions for the set of tasks simultaneously. To achieve this, the MTML model 106 is configured to adjust its model parameters (such as weights, biases, and the like.) in a direction that reduces or minimizes a loss. This model parameter adjustment process may be repeated for each subsequent training cycle of the MTML model 106 till either the set of loss values cease to exist or more likely, the set of loss values saturates or becomes stagnant between subsequent training cycles (this is also known as a predefined criteria). In an embodiment, various optimization algorithms may be used by the MTML model 106 for optimizing/adjusting its model parameters to reduce the set of loss values received from the set of loss functions. In various non-limiting examples, the various optimization algorithms may include gradient descent, Stochastic Gradient Descent (SGD), Adaptive Moment Estimation (ADAM), Root Mean Square Propagation (RMSprop), Adaptive Gradient Algorithm (ADAGRAD), etc., among other suitable algorithms.

It is noted that as described earlier, the conventional MTL techniques suffer from various disadvantages during the training process due to the following scenarios: imbalanced training datasets, dissimilarity between tasks, negative transfer of knowledge, different levels in the difficulty of tasks for which the model has to be trained, different output space for different tasks, and the like. In other words, during MTL when different tasks of varying natures and complexity are being used to train a single model such as MMTL model 106, a few tasks might dominate the learning process. While for other tasks, the respective performance of the model might be compromised due to negative transfer from the dominating tasks. The term ‘negative transfer’ refers to a common problem faced while learning multiple tasks simultaneously, which results in lower accuracy than learning only a single target task. Negative transfer is often attributed to the gradient or loss conflict between different tasks during the learning or training process. As may be understood, the term ‘dominant task’ refers to any task that holds higher significance or priority when compared to other tasks. In an instance, tasks may become dominant during the model training process, if they have more labeled data useful for performing such tasks is available during the training process or if the tasks only have to learn using shallower depths of the neural network. To that end, the dominant tasks may also be called shallower tasks as well.

On the other hand, the term ‘weaker task’ refers to any task that holds lower significance or priority when compared to other tasks. In an instance, tasks may become weaker during the learning process, if they less labeled data available during the training process, less relevant features, high noise (i.e., noisy labeled data), or if the task has to learn from the deeper depths of the neural networks. As may be understood, a negative transfer may generally take place between the weaker tasks and the dominant tasks from the set of tasks due to a variety of reasons. For instance, a negative transfer may be caused due to the weaker tasks may hinder the dominant tasks during the training process and vice versa or conflicting characteristics of the weaker and dominant tasks. In other words, in some scenarios during the MTL process for training an AI or ML model, different tasks may end up overshadowing each other (for instance, dominant tasks tend to overshadow weaker tasks) or different tasks may distract the focus of the model during the learning process (for instance, the model may over-focus on the weaker tasks causing them to dominate the shared set of representations) which leads to an overall decrease in the performance of the model thus, trained.

The above-mentioned technical problem among other problems is addressed by one or more embodiments implemented by the server system 102 of the present disclosure. In one embodiment, the server system 102 is configured to perform one or more of the operations described herein.

In one embodiment, the server system 102 can be a standalone component (acting as a hub) connected to any entity that is capable of operating the server system 102 for training an AI or ML model. In some embodiments, the server system 102 may be associated with the database 104. In other scenarios, the database 104 may be incorporated in the server system 102 or maybe an individual entity connected to the server system 102 or maybe a database stored in cloud storage. In one embodiment, the database 104 may store the MTML model 106, a relational dataset, and other necessary machine instructions required for implementing the various functionalities of the server system 102 such as firmware data, operating system, and the like. In a particular non-limiting instance, the server system 102 may locally store the machine learning model 106 as well. In another embodiment, the server system 102 may locally store a task scheduler 110 as well. In some scenarios, the task scheduler 110 may be stored on the database 104 as well. In an embodiment, the task scheduler 110 may be a hardware or software component running on a hardware component of the server system 102 that is configured to activate or deactivate a subset of tasks from the set of tasks during the MTL process for each iteration.

In an embodiment, the server system 102 is configured to access the training dataset for training the MTML model 106 for a set of tasks from the database 104 associated with the server system. In various non-limiting examples, the training dataset may include information related to a plurality of entities that may be used to train the MTML model 106 to perform the set of tasks. In other words, the training dataset includes information that can be used by the MTML model 106 to learn and make predictions. For instance, in the financial domain, information may be related to a plurality of entities such as a plurality of cardholders, a plurality of merchants, a plurality of acquirers, a plurality of issuers, a plurality of historical transactions, and so on.

In another embodiment, the server system 102 is configured to train the MTML model 106 based, at least in part, on performing a set of operations for a plurality of iterations till the performance of the MTML model converges to a predefined criteria (described earlier). In a particular non-limiting implementation, the set of operations may include initializing the MTML model 106 based, at least in part, on one or more model parameters. It may be understood that one or more model parameters may refer to the weights and biases associated with the AI or ML model. More specifically, the initialization of the MTML model 106 for initializing the MTML model 106 for a first iteration of the plurality of iterations, the server system 102 may be configured to initiate, the MTML model 106 based, at least in part, on one or more initial model parameters. Then, the server system 102 is configured to generate a set of task groups from the set of tasks based, at least in part, on determining an affinity between the each task and one or more tasks from the set of tasks. This task affinity between one task and another task may be represented by a task affinity metric (described later on). Upon generating the set of task groups, the server system 102 may compute a group activation metric for each task group from the set of task groups based, at least in part, on the task affinity metric corresponding to the each task. Herein, the group activation metric corresponding to each task group might indicate the probability of the task group being active during each iteration of the plurality of iterations during the training process. As may be understood, a task group may be referred to as a dominant task group if its corresponding group activation metric is high, i.e., if the probability of this specific task group being activated during the training process is high, then this task group may be called a dominant or stronger task group. Alternatively, a task group may be referred to as a weaker task group if its corresponding group activation metric is low, i.e., if the probability of this specific task group being activated during the training process is low; then this task group may be called a weaker task group. The server system 102 is further configured to identify or select the weakest task group from the set of task groups based, at least in part, on the determining that the group activation metric corresponding to this task group is the lowest from the group activation metrics corresponding to the set of task groups computed earlier. In other words, the weakest task group is selected from the set of task groups based on the least group activation metric from the group activation metric corresponding to the each task group. Then, the server system 102 may be configured to utilize the task scheduler 110 to activate the weakest task group from the set of task groups during the first iteration and then, process the first iteration for the MTML model 106 by performing the weakest task group to learn the one or more model parameters.

As may be understood, by performing the weakest task group from the set of task groups to learn the one or more model parameters and then, initializing the MTML model 106 based on these one or more parameters, a bias towards the weakest task group is introduced in the MTML model 106 thus generated. This bias helps the weakest task group to perform better during the learning process thereby, enhancing the performance of the MTML model 106.

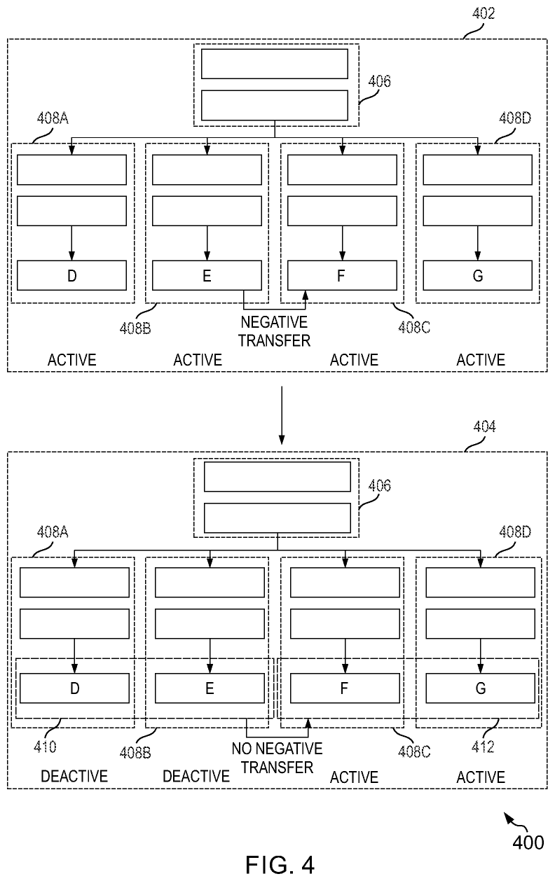

Returning to the previous example, the set of operations may further include computing a task affinity metric for each task of the set of tasks based, at least in part, on determining an affinity between the each task and one or more tasks from the set of tasks. This aspect has been described further in detail later with reference to FIG. 4. Further, the server system 102 may be configured to compute a task-specific activation probability for the each task of the set of tasks based, at least in part, on the task affinity metric corresponding to the each task. Then, the server system 102 is configured to utilize the task scheduler 110 to activate a subset of tasks from the set of tasks based, at least in part, on the task-specific activation probability corresponding to each individual task from the subset of tasks being lower than a predefined threshold. Alternatively, the task scheduler 110 may deactivate the remaining tasks from the set of tasks (i.e., the remaining tasks apart from the subset of tasks) based, at least in part, on the task-specific activation probability corresponding to each individual task from the remaining tasks being at least equal to (i.e., either equal to or higher than) a predefined threshold. In a non-limiting example, the predefined threshold may be defined by an administrator (not shown) associated with the server system 102. As may be understood, task-specific activation probability is the probability associated with a specific task which describes the likelihood of the specific task being activated during the particular iteration. It is noted that when the task-specific activation probability is lower than the predefined threshold, it indicates that the specific task might not get activated, i.e., the task is weaker. Therefore, by forcefully activating this task, learnings from this task may be obtained. It is noted that more than one task may be activated during each iteration as well. As may be understood, since the task-specific activation probability corresponding to each task is based on a task affinity between different tasks, therefore, by activating the subset of tasks using their corresponding task-specific activation probabilities may ensure that similar tasks are activated during each iteration. To that end, since similar tasks are being activated during each iteration, the phenomenon of negative transfer due to dissimilarity between tasks will be mitigated.

Further, the set of operations may further include processing, via the MTML model 106, the training dataset by performing the subset of tasks to compute a set of outputs. Then, server system 102 is configured to generate a set of task-specific losses for the subset of tasks based, at least in part, on the set of outputs and the training dataset. In an embodiment, the set of loss functions described earlier may be responsible for computing the set of task-specific losses for the subset of tasks. Furthermore, the server system 102 is configured to optimize the one or more model parameters based, at least in part, on back-propagating the set of task-specific losses. As described earlier, various optimizing algorithms may be used by the server system 102 to carry out the optimizing operation described herein.

It should be understood that the server system 102 is a separate part of the environment 100, and may operate apart from (but still in communication with, for example, via the network 108) any third-party external servers (to access data to perform the various operations described herein). However, in other embodiments, the server system 102 may be incorporated, in whole or in part, into one or more parts of the environment 100.

It is pertinent to note that the various embodiments of the present disclosure have been described herein with respect to examples from the financial domain, and it should be noted the various embodiments of the present disclosure can be applied to a wide variety of applications as well and the same will be covered within the scope of the present disclosure as well. For instance, for recommender systems, the plurality of entities may be users and items. To that end, the various embodiments of the present disclosure apply to various applications as long as a dataset pertaining to the desired application can be processed by the MTML model 106 after one or more data pre-processing stages.

The number and arrangement of systems, devices, and/or networks shown in FIG. 1 are provided as an example. There may be additional systems, devices, and/or networks: fewer systems, devices, and/or networks: different systems, devices, and/or networks; and/or differently arranged systems, devices, and/or networks than those shown in FIG. 1. Furthermore, two or more systems or devices shown in FIG. 1 may be implemented within a single system or device, or a single system or device is shown in FIG. 1 may be implemented as multiple, distributed systems or devices. In addition, the server system 102 should be understood to be embodied in at least one computing device in communication with the network 108, which may be specifically configured, via executable instructions, to perform steps as described herein, and/or embodied in at least one non-transitory computer-readable media.

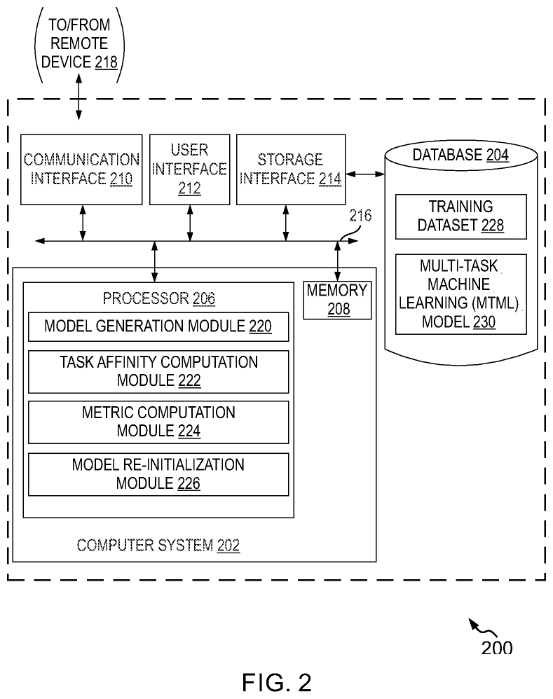

FIG. 2 illustrates a simplified block diagram of a server system 200, in accordance with an embodiment of the present disclosure. It is noted that the server system 200 is identical to the server system 102 of FIG. 1. In various implementations, the server system 200 may be implemented within a third-party server based on an application or industry for which the AI or ML model is being trained. In some embodiments, the server system 200 is embodied as a cloud-based and/or Software as a Service (Saas) based architecture.

The server system 200 includes a computer system 202 and a database 204. It is noted that the database 204 is identical to the database 104 of FIG. 1. The computer system 202 includes at least one processor 206 for executing instructions, a memory 208, a communication interface 210, a user interface 212, and a storage interface 214 that communicate with each other via a bus 216.

In some embodiments, the database 204 is integrated within the computer system 202. For example, the computer system 202 may include one or more hard disk drives as the database 204. The user interface 212 is any component capable of providing an administrator (not shown) of the server system 200, the ability to interact with the server system 200. This user interface 212 may be a GUI or Human Machine Interface (HMI) that can be used by the administrator (not shown) to configure the various operational parameters of the server system 200. The storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In one non-limiting example, the database 204 is configured to store a training dataset 228, a MTML model 230, and the like. It is noted that the MTML model 230 is identical to the MTML model 106 of FIG. 1.

The processor 206 includes suitable logic, circuitry, and/or interfaces to execute operations for activating and deactivating a subset of tasks from a set of tasks being used to train an AI or ML model in order to mitigate the phenomenon of negative transfer between different tasks of the set of tasks. In other words, the processor 206 includes suitable logic, circuitry, and/or interfaces to execute operations for training the MTML model 230. Examples of the processor 206 include but are not limited to, an Application-Specific Integrated Circuit (ASIC) processor, a Reduced Instruction Set Computing (RISC) processor, a Graphical Processing Unit (GPU), a Complex Instruction Set Computing (CISC) processor, a Field-Programmable Gate Array (FPGA), and the like.

The memory 208 includes suitable logic, circuitry, and/or interfaces to store a set of computer-readable instructions for performing various operations described herein. Examples of the memory 208 include a Random-Access Memory (RAM), a Read-Only Memory (ROM), a removable storage drive, a Hard Disk Drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200, without departing from the scope of the present disclosure.

The processor 206 is operatively coupled to the communication interface 210, such that the processor 206 is capable of communicating with a remote device (i.e., to/from a remote device 218) such as a third-party server (not shown), or communicating with any entity connected to the network 116 (as shown in FIG. 1). Herein, the third-party server may be any computing server that operates uses the server system 200 to train any AI or ML model for any specific application using MTL.

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one implementation, the processor 206 includes a model generation module 220, a task affinity computation module 222, a metric computation module 224, and a model re-initialization module 226. It should be noted that components, described herein, such as the model generation module 220, the task affinity computation module 222, the metric computation module 224, and the model re-initialization module 226 can be configured in a variety of ways, including electronic circuitries, digital arithmetic, and logic blocks, and memory systems in combination with software, firmware, and embedded technologies.

In an embodiment, the model generation module 220 includes suitable logic and/or interfaces for accessing a training dataset 228 from the database 204. In various-non-limiting examples, the training dataset 228 may include information related to a plurality of entities. In various non-limiting examples, within the payment eco-system, the plurality of entities may include a plurality of cardholders, a plurality of merchants, a plurality of issuer servers, and a plurality of acquirer servers. Further, the information related to these entities may include information related to a plurality of historical payment transactions performed by the plurality of cardholders with the plurality of merchants. It is noted that this non-limiting example is specific to the financial industry or payment ecosystem however, the various operations of the present disclosure are not limited to the same. To that end, the training dataset 228 can be configured to include different information specific to any field of operation. Therefore, it is understood that the various embodiments of the present disclosure apply to a variety of different fields of operation and the same is covered within the scope of the present disclosure.

Returning to the previous example, the training dataset 228 may include information related to a plurality of historical payment transactions performed within a predetermined interval of time (e.g., 6 months, 12 months, 24 months, etc.). In some other non-limiting examples, the training dataset 228 includes information related to at least merchant name identifier, unique merchant identifier, timestamp information (i.e., transaction date/time), geo-location related data (i.e., latitude and longitude of the cardholder/merchant), Merchant Category Code (MCC), merchant industry, merchant super industry, information related to payment instruments involved in the set of historical payment transactions, cardholder identifier, Permanent Account Number (PAN), merchant name, country code, transaction identifier, transaction amount, and the like.

In one example, the training dataset 228 may define a relationship between each of the plurality of entities. In a non-limiting example, a relationship between a cardholder account and a merchant account may be defined by a transaction performed between them. For instance, when a cardholder purchases an item from a merchant, a relationship is said to be established.

In another embodiment, the training dataset 228 may include information related to past payment transactions such as transaction date, transaction time, geo-location of a transaction, transaction amount, transaction marker (e.g., fraudulent or non-fraudulent), and the like. In yet another embodiment, the training dataset 228 may include information related to a plurality of acquirer servers such as the date of merchant registration with the acquirer server, amount of payment transactions performed at the acquirer server in a day, number of payment transactions performed at the acquirer server in a day, maximum transaction amount, minimum transaction amount, number of fraudulent merchants or non-fraudulent merchants registered with the acquirer server, and the like.

In another embodiment, the model generation module 220 is configured to train the MTML model 230 based, at least in part, on performing a set of operations for a plurality of iterations till the performance of the MTML model converges to a predefined criteria. The predefined criteria may refer to a stage in the iterative learning/training process where the subsequent iterations do not improve the performance of the MTML model 230 or the set of task-specific losses no longer minimize between subsequent iterations. In some scenarios, the predefined criteria may limit the number of iterations to a fixed number. In such scenarios, the predefined criteria may be defined by the administrator of the server system 200.

In various non-limiting examples, the set of operations may include (1) initializing the MTML model 230 based, at least in part, on one or more model parameters, the MTML model 230 may include a set of shared layers and a set of task-specific heads, wherein each task-specific head of the set of task-specific heads includes a set of task-specific layers corresponding to an individual task from the set of tasks, (2) computing a task affinity metric for each task of the set of tasks based, at least in part, on determining an affinity between the each task and one or more tasks from the set of tasks, (3) computing a task-specific activation probability for the each task of the set of tasks based, at least in part, on the task affinity metric corresponding to the each task, (4) activating a subset of tasks from the set of tasks based, at least in part, on the task-specific activation probability corresponding to each individual task from the subset of tasks being lower than a predefined threshold. (5) processing, via the MTML model, the training dataset by performing the subset of tasks to compute a set of outputs. (6) generating a set of task-specific losses for the subset of tasks based, at least in part, on the set of outputs and the training dataset, and (7) optimizing the one or more model parameters based, at least in part, on back-propagating the set of task-specific losses.

In various non-limiting examples, the model generation module 220 is communicably coupled to the task affinity computation module 222, the metric computation module 224, and the model re-initialization module 226 and is configured to utilize these modules to perform the set of operations described herein.

In an embodiment, the task affinity computation module 222 includes suitable logic and/or interfaces for computing a task affinity metric for each task of the set of tasks based, at least in part, on determining an affinity between the each task and one or more tasks from the set of tasks. It is noted that the process for computing the task affinity metric for each task has been described in detail with reference to FIG. 4 later in the present disclosure. To that end, an explanation regarding the same is not provided here for the sake of brevity.

In an embodiment, the metric computation module 224 includes suitable logic and/or interfaces for computing a task-specific activation probability for the each task of the set of tasks based, at least in part, on the task affinity metric corresponding to the each task. In particular, for computing the task-specific activation probability for the each task, the metric computation module 224 is configured to compute, via the MMTL model 230 a set of probability metrics for the each task based, at least in part, on performing the set of tasks. Then, the metric computation module 224 generates the task-specific activation probability for the each task based, at least in part, on aggregating the set of probability metrics and the task affinity metric. In various non-limiting examples, the set of probability metrics for the each task may include a task completion metric, a task stagnancy metric, a regularization metric, etc., among other suitable probability metrics for scheduling tasks. More specifically, the metric computation module 224 is configured to determine via the MMTL model 230, the task completion metric for each task based, at least in part, on comparing the completion state of the each task with the overall completion state of the set of tasks. Further, the metric computation module 224 is configured to compute via the MMTL model, the task stagnancy metric for the each task based, at least in part, on computing a number of iterations from the plurality of iterations where the each task has been stagnant. Furthermore, in an instance, the metric computation module 224 may set the regularization metric for each task as one or unity for any one iteration of the plurality of iterations.

In another embodiment, the metric computation module 224 is configured to activate a subset of tasks from the set of tasks based, at least in part, on the task-specific activation probability corresponding to each individual task from the subset of tasks being lower than a predefined threshold. In an alternative embodiment, the metric computation module 224 is configured to deactivate remaining tasks apart from the subset of tasks from the set of tasks based, at least in part, on the task-specific activation probability corresponding to each individual task from the subset of tasks being equal or greater than the predefined threshold. In other words, the metric computation module 224 is configured to schedule a subset of tasks to either switch ON or OFF, i.e., activate or deactivate based, at least in part, on the predefined threshold. Therefore, the metric computation module 224 is responsible for acting as a task scheduler such as task scheduler 110 of FIG. 1. As may be understood, activating a subset of tasks from the set of tasks allows the MTML model 230 to mitigate the effects of negative transfer since only similar tasks or tasks with similar affinity are activated at a time during the iterative learning process. In other words, dissimilar tasks are not activated together which helps to mitigate the phenomenon of negative transfer.

In an embodiment, the model re-initialization module 226 is configured to perform a biased initialization for the MTML model 230. In particular, the model re-initialization module 226 is configured to perform biased initialization during a first iteration of the plurality of iterations. In a non-limiting implementation, the biased initialization process includes initiating, the MTML model based, at least in part, on one or more initial model parameters. Then, the biased initialization process includes generating a set of task groups from the set of tasks based, at least in part, on the task affinity metric for each task of the set of tasks. Then, the biased initialization process includes computing a group activation metric for each task group from the set of task groups based, at least in part, on the task affinity metric corresponding to the each task. Thereafter, the biased initialization process includes activating the weakest task group from the set of task groups based, at least in part, on the group activation metric corresponding to the weakest task group. It is noted that the weakest task group is selected from the set of task groups based on the weakest task group having the least group activation metric from the group activation metric corresponding to the each task group.

Finally, the biased initialization process includes processing the MTML model by performing the weakest task group to learn the one or more model parameters. As may be understood, by biasing the initialization process for the MTML model 230, the MTML model 230 being trained for the successive iterative processes will be able to learn representations from the weaker tasks more accurately. To that end, the MTML model 230 thus trained after the plurality of iterations would have higher performance than a convention AI or ML model that is initialized randomly.

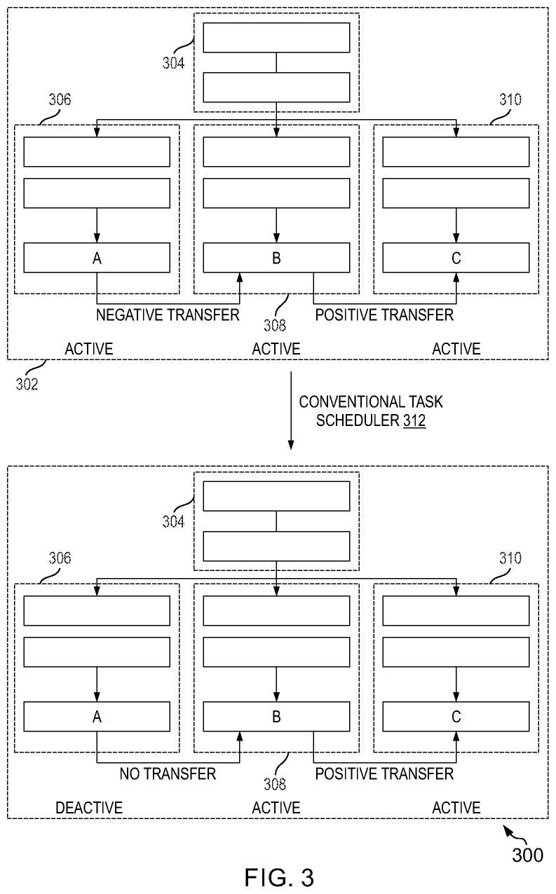

FIG. 3 illustrates an example representation of a conventional architecture of Multi-Task Learning using Dropped Scheduled Task (DST), in accordance with an example of the present disclosure.

In an embodiment, a conventional machine learning model 302 may include a set of shared layers 304 and a set of task-specific heads (see. 306, 308 and 310). Each task-specific head is further depicted to include a set of task-specific layers. In the illustrated example, each task-specific head is configured to learn by performing a particular task. As depicted, the task-specific head 306 is configured to perform task A, the task-specific head 308 is configured to perform task B, and the task-specific head 310 is configured to perform task C. Conventionally, if MTL is performed using this conventional machine learning model 302, then negative transfer may take place between task B and A while positive transfer may take place between task C and B.

As may be understood, the conventional DST algorithm aims to mitigate this negative transfer by tackling four factors that lead to negative transfer in MTL while training a machine learning model. The four factors considered by DST are network depth, ground-truth sample count, task incompleteness, and task stagnation. In particular, DST describes computing the task-wise activation probability based on four metrics. The four metrics are network depth metric, training sample count metric, task incompleteness metric, and regularization metric. More specifically for each t^{th} task in MTL, these four factors are quantified by a respective metric to quantify the deactivation rate for a task from the set of tasks during the training process. For t^{th} task, [symbol] provides the deactivation rate based on task depth and [symbol] provides the deactivation rate based on the training sample count. Additionally, at k^{th} epoch, [symbol] and [symbol] provides the deactivation rate based on task incompleteness and stagnancy, respectively. As may be understood, these individual metrics indicate the degree of confidence regarding if a task is dominant during the MTL process. These metrics are combined to define a task-wise activation probability P_{(k,t)}, where P_{(k,t)} ranges in [0,1]. P_{(k,t)} tells what are the chances of t^{th} task to remain active on k^{th} epoch. In an example, the task-wise activation probability P_{(k,t)} may be defined by the following Eqn. 1:

$${P}_{( k , t )} = {λ}_{d} {𝒫}_{( d , t )} + {λ}_{c} {𝒫}_{( c , t )} + {λ}_{u} {𝒫}_{( s , k , t )} + {λ}_{r} {𝒫}_{( r , k , t )} + {λ}_{b} {𝒫}_{( b , t )} \qquad Eqn . 1$$

Here, λ are non-negative weights given to individual metrics such that Σλᵢ=1. These λᵢ can be altered to address specific variations of data, network, and learning in the MTL process for an AI or ML model.

Herein, the conventional DST algorithm may be implemented by a conventional task-scheduler (see, 312) which is configured to deactivate the task A while task B and task C remain active to ensure positive transfer between task B and task C while eliminating negative transfer from task A.

As described earlier, the conventional DST algorithm fails to consider task affinities and task grouping while activating or deactivating tasks during the learning process. To that end, in various scenarios during the learning process, dissimilar tasks may be activated together while similar tasks may be deactivated, which in itself may cause a gradient conflict between different tasks during the MTL process that further leads to poor learning by the AI or ML model being trained. Further, the conventional DST algorithm initializes the machine learning model based on a random initialization approach which also fails to consider a bias for the weaker task groups in the MTL process.

FIG. 4 illustrates an example representation 400 of an architecture of a Multi-Task Machine Leaning (MTML) model, in accordance with an embodiment of the present disclosure. As described earlier, while training a machine learning model using a set of tasks, the problem of negative transfer has to be mitigated or minimized. To that end, the conventional DST algorithm (described in reference to FIG. 3) provided a cumulative activation probability generated using five different metrics. The cumulative activation probability (i.e., the task-wise activation probability) was responsible for activating or deactivating tasks. It is noted that since, this independent activation or deactivation of tasks from the set of tasks did not consider the task relatedness and the affinity between different tasks, this training methodology led to dissimilar tasks being activated during the same training epoch (or in some scenarios, during the same iteration within the epoch). Thus, leading to gradient conflicts during the learning process. To that end, it is understood that for avoiding these gradient conflicts while training the MTML model, the aspects of task relatedness and task affinity must be considered.

As illustrated, the conventional machine learning model 402 is similar to conventional machine learning model 302 of FIG. 3. To that end, the same is not described again for the sake of brevity. As illustrated, the MTML model 404 is configured to implement the various embodiments of the present disclosure to deactivate dissimilar tasks while activating similar tasks. In other words, tasks belonging to similar tasks groupings are activated together to improve the performance of the MTML model 404.

As illustrated, if tasks D, E, F, and G have to be trained using the MTL approach described herein, such that tasks D and E are dissimilar to tasks F and G. Then, in such as scenario, the approach of the present disclosure may be implemented by a task-scheduler which may deactivate the tasks D and E while task F and task G remain active to ensure positive transfer between task F and task G while eliminating negative transfer and conflicting gradients from being shared from tasks D and E during the MTL process.

In order to achieve this, at first, a task affinity of a task from the set of tasks with respect to other tasks from the set of tasks is determined. This affinity between different tasks may be represented or described by a task affinity metric. In order to determine the affinity between different tasks in the set of tasks, a task affinity matrix may be generated. This task affinity matrix may then be used to compute the task affinity metric [symbol] for the various tasks being learned during the MTL process by the MMTL model. Then, the task affinity metric [symbol] corresponding to each task of the set of tasks may be used to compute a task-specific activation probability P_{k,t} for each task of the set of tasks.

In a particular implementation, for computing the task affinity metric [symbol] for each task, the effect of the updates in gradients caused by each task on other tasks from the set of tasks has to be determined. In other words, to determine the affinity between different tasks, it may be determined how gradient updates due to a task Tᵢ affects another task Tⱼ at the shared layers of a deep learning neural network of the MMTL model during the MTL process. For instance, if the forward-looking weight update due to the task Tᵢ at the shared layers, positively impacts the task Tⱼ (i.e., the weight updates due to task Tᵢ causes the loss Lⱼ for task Tⱼ to decrease), then the tasks Tᵢ and Tᵢ can be said to be related to each other, i.e., they have an affinity between them. In other words, the task affinity between these tasks is higher. In a non-limiting example, the following Eqn. 2 may be used to denote the affinity at iteration k:

$${Z}_{j \to i}^{k} = 1 - \frac{{L}_{j}^{( k + 1 ) \vert {θ}_{i}^{k + 1}}}{{L}_{j}^{k}} \qquad Eqn . 2$$

In a non-limiting example, if a task Tᵢ causes a positive impact on the task Tⱼ, i.e.,

$${L}_{j}^{( k + 1 ) \vert {θ}_{i}^{k + 1}} < {L}_{j}^{k}$$

then, Z_{j→i}^{k} indicates a positive affinity between tasks Tᵢ and Tⱼ. Conversely, if the task Tᵢ causes a negative impact on the task Tⱼ, i.e.,

$${L}_{j}^{( k + 1 ) \vert {θ}_{i}^{k + 1}} > {L}_{j}^{k} ,$$

then, Z_{j→i}^{k} indicates a negative affinity between tasks Tᵢ and Tⱼ. In other words, if the weight update on shared layers of the deep neural network due to task Tᵢ harms the learning of task Tⱼ then, the tasks Tᵢ and Tⱼ can be said to be not related to each other that closely. Thus, the task affinity between these tasks is lower, i.e., negative affinity exists between these tasks. In a particular instance, a generalized score at the training or epoch level can then be computed as

$${\hat{Z}}_{j \to i}^{k} = \frac{1}{2} {\sum }_{k = 1}^{K} {Z}_{j \to i}^{k} .$$

Further, using Z_{j→i}^{k}, a set of task groups from the set of tasks may be computed. In various non-limiting examples, for performing the task grouping based on the corresponding task affinities for each task of the set of tasks, various grouping algorithms may be utilized. In a non-limiting example, a branch and bound algorithm may be used to perform the task groupings

It is noted that once the set of task groups is created based on the determined task affinity, the next step is to create the task affinity metric [symbol] . In a particular implementation, for all tasks Tᵢ⊆T, where Tᵢ are number of tasks in the i^{th} group, the task affinity metric [symbol] can be defined as:

$${𝒫}_{( k , t )}^{a} = \{ \begin{matrix}\frac{1}{2} * ( 1 + sin \frac{2 π k}{M} ) if k ∈ ( n * ( i - 1 ) , n * i ] ; \\ \frac{1}{2} * sin \frac{2 π k}{M}\end{matrix}$$

Here, k is the training epoch, M is the total number of a set of task groups, n is a series of non-zero natural numbers, such that n is determined based on k. In one instance, n takes on values 1, 2, 3 . . . depending on values of k to make the entire metric periodic.

Further, in an embodiment, for computing the task-specific activation probability of each task, apart from the task affinity metric corresponding to that task, a set of probability metrics for the each task may also be used. In one instance, the MMTL model may compute the set of probability metrics for each task of the set of tasks based, at least in part, on performing the set of tasks. In various non-limiting examples, the set of probability metrics for each task may include at least one of a task completion metric, a task stagnancy metric, a regularization metric, etc., among other suitable metrics. It is noted that the task completion metric, the task stagnancy metric, and the regularization metric may be represented as [symbol] , [symbol] , and [symbol] , herein respectively.

In an embodiment, the task completion metric for each task from the set of tasks may be determined based, at least in part, on comparing the completion state of the each task with the overall completion state of the set of tasks. In one implementation, the MMTL model may compute the task completion metric for each task from the set of tasks based, at least in part, on comparing the completion state of the each task with the overall completion state of the set of tasks. In a non-limiting example, the following Eqn. 3 given below may be used to compute the task completion metric for each task from the set of tasks:

$${𝒫}_{( k , t )}^{b} = min ( 1 , \frac{{I}_{( k , t )}}{E ( {I}_{( k )} )} ) \qquad Eqn . 3$$

where, I_{(k,t)} is the ratio of the current loss value over the initial loss value for t^{th} task and E(I₍ₖ₎) is the expected value across all tasks in the MTL process for the MMTL model 230.

In another embodiment, the task stagnancy metric for each task from the set of tasks may be determined based, at least in part, on computing a number of iterations from the plurality of iterations where the each task has been stagnant. In one implementation, the MMTL model may compute the task stagnancy metric for each task from the set of tasks may be determined based, at least in part, on computing a number of iterations from the plurality of iterations where the each task has been stagnant. In other words, [symbol] computes the duration for which the loss value for each task has been stagnant and aims to activate tasks that have been stagnant for a few iterations. In another embodiment, the regularization metric for each task may be set as unity for at least one iteration of the plurality of iterations to ensure that each task is performed at least once. In other words, [symbol] is a regularization to prevent tasks from remaining OFF or deactivated forever, thus, limiting catastrophic forgetting.

To that end, the task-specific activation probability for each task of the set of tasks may be computed by aggregating the set of probability metrics with the task affinity metric for the corresponding task from the set of tasks. In a non-limiting example, the following Eqn. 4 may be used to compute the task-specific activation probability for each task of the set of tasks:

$${P}_{( k , t )} = {λ}_{1} {𝒫}_{( k , t )}^{a} + {λ}_{2} {𝒫}_{( k , t )}^{b} + {λ}_{3} {𝒫}_{( k , t )}^{c} + {λ}_{4} {𝒫}_{( k , t )}^{a} \qquad Eqn . 4$$

where, Σλᵢ=1. For each task, its activation is decided by sampling 1 or 0 gates using the P_{(k,t)}, sampled from an independent Bernoulli distribution, hence scheduling tasks at each epoch. In other words, each task of the set of tasks is configured to either be activated or deactivated by 1 or 0 gates, respectively based, at least in part, on the corresponding task-specific activation probability for that task. For instance, if the task-specific activation probability of task A is lower than a predefined threshold, then task A can be activated or switched ON for that epoch or iteration. In an alternative instance, if the task-specific activation probability of task A is at least equal to (i.e., equal or greater to) a predefined threshold, then task A can be deactivated or switched OFF for that epoch or iteration.

As descried earlier with reference to FIG. 3, the conventional DST algorithm randomly initializes the machine learning model during the MTL process. This aspect of DST leads to poor learning performance on weaker tasks from the set of tasks. To that end, in another embodiment, the server system 200 may be configured to bias the MMTL model during the network initialization stage for the weakest task group from the set of task groups for improving the performance of the MMTL model. In particular, for improving the network initialization in the MTL learning process for the MMTL model, upon determining the task affinities and task groupings, the server system 200 computes inter-group affinities. As may be understood, upon using the inter-group affinities, the multi-task network may be initialized by network weights learned from tasks belonging to the group with minimum inter-group affinity. This aspect ensures that the network weights are in a space where the remaining tasks don't dominate the less related task group. More specifically, the server system 200 computes a group activation metric for each task group from the set of task groups based, at least in part, on the task affinity metric corresponding to the each task in each task group. Then, the server system 200 activates a weakest task group (i.e., a task group with the lowest or least group activation metric) from the set of task groups based, at least in part, on the group activation metric corresponding to the weakest task group. The weights learned from this weakest task group are then used to initialize the MMTL model for the training process.

In a non-limiting implementation, the formulation for an inter-group affinity metric may be done using the following Eqn. 5:

$${A}_{i} = \frac{{\sum }_{t = 1}^{T} {\sum }_{j = 1}^{J} {τ}_{t , j}}{{N}_{t} * {N}_{j}} \qquad Eqn . 5$$

where, Aᵢ is the group activation metric of the each task group i, τ_{t,j} is the task affinity metric of a task t belonging to the each task group i while task j is outside the each task group i, Nₜ is the number of tasks in the each task group i, and Nⱼ is the remaining number of tasks in the set of tasks.

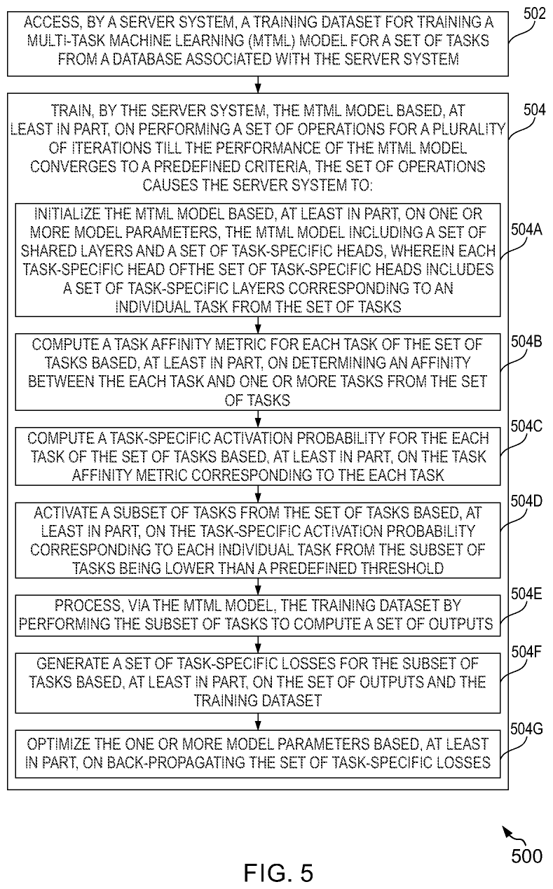

FIG. 5 illustrates a process flow diagram depicting a method 500 for mitigating negative transfer during Multi-Task Learning (MTL) while training a machine learning model such as MTML model 234, in accordance with an embodiment of the present disclosure. The method 500 depicted in the flow diagram may be executed by, for example, the server system 200. The sequence of operations of the method 500 may not be necessarily executed in the same order as they are presented. Further, one or more operations may be grouped and performed in the form of a single step, or one operation may have several sub-steps that may be performed in parallel or in a sequential manner. Operations of the method 500, and combinations of operations in the method 500 may be implemented by, for example, hardware, firmware, a processor, circuitry, and/or a different device associated with the execution of software that includes one or more computer program instructions. The plurality of operations is depicted in the process flow of the method 500. The process flow starts at operation 502.

At 502, the method 500 includes accessing, by a server system such as server system 200 of FIG. 2, a training dataset such as training dataset 228 for training a multi-task machine learning (MTML) model such as MTML model 230 for a set of tasks from a database such as database 204 associated with the server system 200.

At 504, the method 500 includes training, by the server system 200, the MTML model 230 based, at least in part, on performing a set of operations for a plurality of iterations till the performance of the MTML model 230 converges to a predefined criteria. In an implementation, the set of operations includes sub-operations 504A-504G. It is noted that predefined criteria may refer to a point in the iterative process where the values for a set of task-specific losses corresponding to each task of the set of tasks either minimizes or saturates (i.e., stops or effectively ceases to decrease with successive iterations).

At 504A, the method 500 includes initializing the MTML model 230 based, at least in part, on one or more model parameters. Herein, the MTML model 230 may include a set of shared layers and a set of task-specific heads, wherein each task-specific head of the set of task-specific heads includes a set of task-specific layers corresponding to an individual task from the set of tasks.

At 504B, the method 500 includes computing a task affinity metric for each task of the set of tasks based, at least in part, on determining an affinity between the each task and one or more tasks from the set of tasks.

At 504C, the method 500 includes computing a task-specific activation probability for the each task of the set of tasks based, at least in part, on the task affinity metric corresponding to the each task.

At 504D, the method 500 includes activating a subset of tasks from the set of tasks based, at least in part, on the task-specific activation probability corresponding to each individual task from the subset of tasks being lower than a predefined threshold.

At 504E, the method 500 includes processing, via the MTML model 230, the training dataset by performing the subset of tasks to compute a set of outputs.

At 504F, the method 500 includes generating a set of task-specific losses for the subset of tasks based, at least in part, on the set of outputs and the training dataset 228.

At 504G, the method 500 includes optimizing the one or more model parameters based, at least in part, on back-propagating the set of task-specific losses.

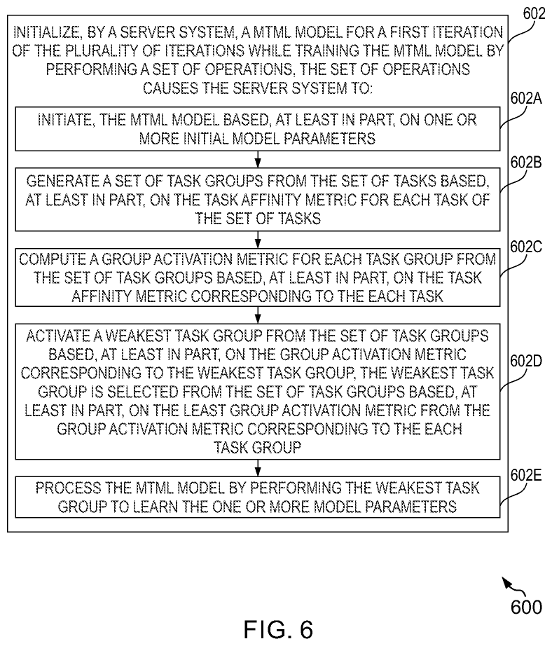

FIG. 6 illustrates a process flow diagram depicting a method for initializing a Multi-Task Machine Leaning (MTML) model such as the MTML model 230, in accordance with an embodiment of the present disclosure. The method 600 depicted in the flow diagram may be executed by, for example, the server system 200. The sequence of operations of the method 600 may not be necessarily executed in the same order as they are presented. Further, one or more operations may be grouped and performed in the form of a single step, or one operation may have several sub-steps that may be performed in parallel or in a sequential manner. Operations of the method 600, and combinations of operations in the method 600 may be implemented by, for example, hardware, firmware, a processor, circuitry, and/or a different device associated with the execution of software that includes one or more computer program instructions. The plurality of operations is depicted in the process flow of the method 600. The process flow starts at operation 602.

At 602, the method 600 includes initializing, by a server system such as server system 200, a MTML model 230 for a first iteration of the plurality of iterations while training the MTML model 230 by performing a set of operations. The set of operations may include sub-operations 602A-602D given below.

At 602A, the method 600 includes initiating, the MTML model based, at least in part, on one or more initial model parameters.

At 602B, the method 600 includes generating a set of task groups from the set of tasks based, at least in part, on the task affinity metric for each task of the set of tasks.

At 602C, the method 600 includes computing a group activation metric for each task group from the set of task groups based, at least in part, on the task affinity metric corresponding to the each task.

At 602D, the method 600 includes activating a weakest task group from the set of task groups based, at least in part, on the group activation metric corresponding to the weakest task group. Herein, the weakest task group is selected from the set of task groups based, at least in part, on the least group activation metric from the group activation metric corresponding to the each task group. In other words, the weakest task group may have the lowest group activation metric.

At 602E, the method 600 includes processing the MTML model by performing the weakest task group to learn the one or more model parameters.

The disclosed method with reference to FIG. 5-6, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means include, for example, the Internet, the World Wide Web (WWW), an intranet, software applications, cable (including fiber optic cable), magnetic communications, electromagnetic communications (including RF, microwave, and infrared communications), electronic communications, or other such communication means.

Although the invention has been described with reference to specific example embodiments, it is noted that various modifications and changes may be made to these embodiments without departing from the broad spirit and scope of the invention. For example, the various operations, blocks, etc., described herein may be enabled and operated using hardware circuitry (for example, Complementary Metal Oxide Semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, Application Specific Integrated Circuit (ASIC) circuitry and/or in Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause the processor or the computer to perform one or more operations. A computer-readable medium storing, embodying, or encoded with a computer program, or similar language, may be embodied as a tangible data storage device storing one or more software programs that are configured to cause the processor or computer to perform one or more operations. Such operations may be, for example, any of the steps or operations described herein. In some embodiments, the computer programs may be stored and provided to a computer using any type of non-transitory computer-readable media. Non-transitory computer-readable media includes any type of tangible storage media. Examples of non-transitory computer-readable media include magnetic storage media (such as floppy disks, magnetic tapes, hard disk drives, etc.), optical magnetic storage media (e.g. magneto-optical disks), Compact Disc Read-Only Memory (CD-ROM), Compact Disc Recordable (CD-R), compact disc rewritable (CD-R/W), Digital Versatile Disc (DVD), BLU-RAY® Disc (BD), and semiconductor memories (such as mask ROM, programmable ROM (PROM), (erasable PROM), flash memory, Random Access Memory (RAM), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based on these example embodiments, it is noted that certain modifications, variations, and alternative constructions may be apparent and well within the spirit and scope of the invention.

Although various example embodiments of the invention are described herein in a language specific to structural features and/or methodological acts, the subject matter defined in the appended claims is not necessarily limited to the specific features or acts described above. Rather, the specific features and acts described above are disclosed as example forms of implementing the claims.

What is claimed is:

1. A computer-implemented method, comprising:
accessing, by a server system, a training dataset for training a multi-task machine learning (MTML) model for a set of tasks from a database associated with the server system; and
training, by the server system, the MTML model based, at least in part, on performing a set of operations for a plurality of iterations till the performance of the MTML model converges to a predefined criteria, the set of operations comprising:
initializing the MTML model based, at least in part, on one or more model parameters, the MTML model comprising a set of shared layers and a set of task-specific heads, wherein each task-specific head of the set of task-specific heads comprises a set of task-specific layers corresponding to an individual task from the set of tasks;
computing a task affinity metric for each task of the set of tasks based, at least in part, on determining an affinity between the each task and one or more tasks from the set of tasks;
computing a task-specific activation probability for the each task of the set of tasks based, at least in part, on the task affinity metric corresponding to the each task;
activating a subset of tasks from the set of tasks based, at least in part, on the task-specific activation probability corresponding to each individual task from the subset of tasks being lower than a predefined threshold;
processing, via the MTML model, the training dataset by performing the subset of tasks to compute a set of outputs;
generating a set of task-specific losses for the subset of tasks based, at least in part, on the set of outputs and the training dataset; and
optimizing the one or more model parameters based, at least in part, on back-propagating the set of task-specific losses.

2. The computer-implemented method as claimed in 1, wherein initializing the MTML model for a first iteration of the plurality of iterations comprises:
initiating, the MTML model based, at least in part, on one or more initial model parameters;
generating a set of task groups from the set of tasks based, at least in part, on the task affinity metric for each task of the set of tasks;
computing a group activation metric for each task group from the set of task groups based, at least in part, on the task affinity metric corresponding to the each task;
activating a weakest task group from the set of task groups based, at least in part, on the group activation metric corresponding to the weakest task group, the weakest task group selected from the set of task groups based on least group activation metric from the group activation metric corresponding to the each task group; and
processing the MTML model by performing the weakest task group to learn the one or more model parameters.

3. The computer-implemented method as claimed in 1, wherein computing the task-specific activation probability further comprises:
computing, via the MMTL model a set of probability metrics for the each task based, at least in part, on performing the set of tasks; and
generating the task-specific activation probability for the each task based, at least in part, on aggregating the set of probability metrics and the task affinity metric.

4. The computer-implemented method as claimed in 3, wherein the set of probability metrics for the each task comprises at least one of a task completion metric, a task stagnancy metric, and a regularization metric.

5. The computer-implemented method as claimed in 4, further comprising:
determining via the MMTL model, the task completion metric for each task based, at least in part, on comparing the completion state of the each task with the overall completion state of the set of tasks.

6. The computer-implemented method as claimed in 4, further comprising:
computing via the MMTL model, the task stagnancy metric for the each task based, at least in part, on computing a number of iterations from the plurality of iterations where the each task has been stagnant.

7. The computer-implemented method as claimed in 4, wherein the regularization metric for each task is set as unity for one iteration of the plurality of iterations.

8. The computer-implemented method as claimed in 1, wherein the task affinity metric for each task is computed as:
$${𝒫}_{( k , t )}^{a} = \{ \begin{matrix}\frac{1}{2} * ( 1 + sin \frac{2 π k}{M} ) if k ∈ ( n * ( i - 1 ) , n * i ] ; \\ \frac{1}{2} * sin \frac{2 π k}{M}\end{matrix}$$
wherein, k is the training epoch, M is the total number of a set of task groups, n is a series of non-zero natural numbers, wherein n is determined based on k.

9. The computer-implemented method as claimed in 1, wherein the group activation metric for each task group from the set of task groups is computed as:
$${A}_{i} = \frac{{\sum }_{t = 1}^{T} {\sum }_{j = 1}^{J} {τ}_{t , j}}{{N}_{t} * {N}_{j}}$$
wherein, Aᵢ is the group activation metric of the each task group i, τ_{t,j} is the task affinity metric of a task t belonging to the each task group i while task j is outside the each task group i, Nₜ is the number of tasks in the each task group i, and Nⱼ is the remaining number of tasks in the set of tasks.

10. A server system, comprising:
a memory configured to store instructions;
a communication interface; and
a processor in communication with the memory and the communication interface, the processor configured to execute the instructions stored in the memory and thereby cause the server system to perform at least in part to:
access a training dataset for training a multi-task machine learning (MTML) model for a set of tasks from a database associated with the server system; and
train the MTML model based, at least in part, on performing a set of operations for a plurality of iterations till the performance of the MTML model converges to a predefined criteria, the set of operations comprising:
initializing the MTML model based, at least in part, on one or more model parameters, the MTML model comprising a set of shared layers and a set of task-specific heads, wherein each task-specific head of the set of task-specific heads comprises a set of task-specific layers corresponding to an individual task from the set of tasks;
computing a task affinity metric for each task of the set of tasks based, at least in part, on determining an affinity between the each task and one or more tasks from the set of tasks;
computing a task-specific activation probability for the each task of the set of tasks based, at least in part, on the task affinity metric corresponding to the each task;
activating a subset of tasks from the set of tasks based, at least in part, on the task-specific activation probability corresponding to each individual task from the subset of tasks being lower than a predefined threshold;
processing, via the MTML model, the training dataset by performing the subset of tasks to compute a set of outputs;
generating a set of task-specific losses for the subset of tasks based, at least in part, on the set of outputs and the training dataset; and
optimizing the one or more model parameters based, at least in part, on back-propagating the set of task-specific losses.

11. The server system as claimed in claim 10, wherein for initializing the MTML model for a first iteration of the plurality of iterations, the server system is further caused, at least in part, to:
initiate, the MTML model based, at least in part, on one or more initial model parameters;
generate a set of task groups from the set of tasks based, at least in part, on the task affinity metric for each task of the set of tasks;
compute a group activation metric for each task group from the set of task groups based, at least in part, on the task affinity metric corresponding to the each task;
activate a weakest task group from the set of task groups based, at least in part, on the group activation metric corresponding to the weakest task group, the weakest task group selected from the set of task groups based on least group activation metric from the group activation metric corresponding to the each task group; and
process the MTML model by performing the weakest task group to learn the one or more model parameters.

12. The server system as claimed in claim 10, wherein for computing the task-specific activation probability, the server system is further caused, at least in part, to:
compute, via the MMTL model a set of probability metrics for the each task based, at least in part, on performing the set of tasks; and
generate the task-specific activation probability for the each task based, at least in part, on aggregating the set of probability metrics and the task affinity metric.

13. The server system as claimed in claim 12, wherein the set of probability metrics for the each task comprises at least one of a task completion metric, a task stagnancy metric, and a regularization metric.

14. The server system as claimed in claim 13, wherein the server system is further caused, at least in part, to:
determine via the MMTL model, the task completion metric for each task based, at least in part, on comparing the completion state of the each task with the overall completion state of the set of tasks.

15. The server system as claimed in claim 13, wherein the server system is further caused, at least in part, to:
compute via the MMTL model, the task stagnancy metric for the each task based, at least in part, on computing a number of iterations from the plurality of iterations where the each task has been stagnant.

16. The server system as claimed in claim 13, wherein the regularization metric for each task is set as unity for one iteration of the plurality of iterations.

17. The server system as claimed in claim 10, wherein the task affinity metric for each task is computed as:
$${𝒫}_{( k , t )}^{a} = \{ \begin{matrix}\frac{1}{2} * ( 1 + sin \frac{2 π k}{M} ) if k ∈ ( n * ( i - 1 ) , n * i ] ; \\ \frac{1}{2} * sin \frac{2 π k}{M}\end{matrix}$$
wherein, k is the training epoch, M is the total number of a set of task groups, n is a series of non-zero natural numbers, wherein n is determined based on k.

18. The server system as claimed in claim 10, wherein the group activation metric for each task group from the set of task groups is computed as:
$${A}_{i} = \frac{{\sum }_{t = 1}^{T} {\sum }_{j = 1}^{J} {τ}_{t , j}}{{N}_{t} * {N}_{j}}$$
wherein, Aᵢ is the group activation metric of the each task group i, τ_{t,j} is the task affinity metric of a task t belonging to the each task group i while task j is outside the each task group i, Nₜ is the number of tasks in the each task group i, and Nⱼ is the remaining number of tasks in the set of tasks.

19. A non-transitory computer-readable storage medium comprising computer-executable instructions that, when executed by at least a processor of a server system, cause the server system to perform a method comprising:
accessing a training dataset for training a multi-task machine learning (MTML) model for a set of tasks from a database associated with the server system; and
training the MTML model based, at least in part, on performing a set of operations for a plurality of iterations till the performance of the MTML model converges to a predefined criteria, the set of operations comprising:
initializing the MTML model based, at least in part, on one or more model parameters, the MTML model comprising a set of shared layers and a set of task-specific heads, wherein each task-specific head of the set of task-specific heads comprises a set of task-specific layers corresponding to an individual task from the set of tasks;
computing a task affinity metric for each task of the set of tasks based, at least in part, on determining an affinity between the each task and one or more tasks from the set of tasks;
computing a task-specific activation probability for the each task of the set of tasks based, at least in part, on the task affinity metric corresponding to the each task;
activating a subset of tasks from the set of tasks based, at least in part, on the task-specific activation probability corresponding to each individual task from the subset of tasks being lower than a predefined threshold;
processing, via the MTML model, the training dataset by performing the subset of tasks to compute a set of outputs;
generating a set of task-specific losses for the subset of tasks based, at least in part, on the set of outputs and the training dataset; and
optimizing the one or more model parameters based, at least in part, on back-propagating the set of task-specific losses.

20. The non-transitory computer-readable storage medium as claimed in 19, wherein for initializing the MTML model for a first iteration of the plurality of iterations, the method further comprises:
initiating, the MTML model based, at least in part, on one or more initial model parameters;
generating a set of task groups from the set of tasks based, at least in part, on the task affinity metric for each task of the set of tasks;
computing a group activation metric for each task group from the set of task groups based, at least in part, on the task affinity metric corresponding to the each task;
activating a weakest task group from the set of task groups based, at least in part, on the group activation metric corresponding to the weakest task group, the weakest task group selected from the set of task groups based on least group activation metric from the group activation metric corresponding to the each task group; and
processing the MTML model by performing the weakest task group to learn the one or more model parameters.
